(19) United States
(12) Patent Application Publication
(10) Pub. No.: US 2006/0017293 A1
(43) Pub. Date: Jan. 26, 2006

(54) Lock particularly for cases, trunks and the like

(75) Inventor: Massimo Tonelli, Casalecchio Di Reno (IT)

Correspondence Address: MODIANO & ASSOCIATI, Via Meravigli, 16, MILAN, 20123, IT

(73) Assignee: GT LINE S.R.L.

(21) Appl. No.: 11/181,759

(22) Filed: Jul. 15, 2005

(30) Foreign Application Priority Data
Jul. 22, 2004 (IT) BO2004A000455

(51) Int. Cl. E05C 3/04

(52) U.S. Cl. 292/202

(57) ABSTRACT

A lock for cases, that fastens hermetically against each other the first half-shell and the second half-shell of the case, having at least one clamp articulated to the first half-shell and forming a folded end portion, which can rotate from an angular position for closing the case, in which the folded end portion is engaged with a snap action under the edge of the second half-shell to keep it in contact with the first half-shell, to an angular position for freely opening the case, in which the folded end portion is disengaged from the edge, the clamp being provided with a quick release lever, which is actuated manually and is suitable to disengage the folded end portion from the edge for moving the clamp into the angular position for freely opening the case.

The present invention relates to a lock particularly for cases, such as luggage boxes and luggage items in general, suitcases, trunks and the like.

### BACKGROUND OF THE INVENTION

Various fields, including non-professional fields, use cases, trunks or other similar portable containers constituted by two half-shells, which are mutually articulated and have respective edges that, when the case is closed, are pressed against each other by the locking action applied by one or more locks, so as to provide substantial tightness with respect for example to water or impurities; for this purpose, special perimetric gaskets are often also provided which are fitted along said edges.

It is known that particular applications and uses require increasingly perfect and reliable sealing conditions, which must of course be ensured by the action of the locks: said locks must in fact produce a slight compressive deformation of the edges (or of the gaskets) against each other.

Accordingly, especially in order to open the locks of the case, the manual action to be applied thereto is rather demanding and awkward, since said locks have to be released from the locking position in which they press the edges against each other elastically: it is evident that especially for large cases or trunks, the user must apply a considerable release force, and this may constitute an intolerable drawback in certain situations.

### SUMMARY OF THE INVENTION

The aim of the present invention is to obviate the cited drawback, by providing a lock, particularly for cases, trunks and the like, that is suitable to be opened quickly and easily, i.e., by applying a very modest manual release action.

Within this aim, an object of the present invention is to provide a lock, particularly for cases, trunks and the like, that is absolutely versatile and applicable to any type of portable container, particularly to containers in which it is necessary to achieve effective closure tightness.

Another object of the present invention is to provide a structure that is simple, relatively easy to provide in practice, safe in use, effective in operation, and has a relatively low cost.

This aim and these and other objects that will become better apparent hereinafter are achieved by the present lock, particularly for cases, trunks and the like, for fastening hermetically against each other the first half-shell and the second half-shell of the case, characterized in that it comprises at least one clamp, which is articulated to said first half-shell and forms a substantially folded end portion, which can rotate from an angular position for closing the case, in which said folded end portion is engaged with a snap action under the edge of said second half-shell in order to keep it in contact with said first half-shell, to an angular position for freely opening the case, in which said folded end portion is disengaged from said edge, said clamp being provided with means for rapid release of the lever type, which are actuated manually and are suitable to disengage said folded end portion from said edge so as to move said clamp into said angular position for freely opening said case.

### BRIEF DESCRIPTION OF THE DRAWINGS

Further characteristics and advantages will become better apparent from the following detailed description of a preferred but not exclusive embodiment of a lock for cases, trunks and the like according to the invention, illustrated by way of non-limiting example in the accompanying drawings, wherein:

FIG. 1 is a perspective view of a case equipped with two locks according to the invention;

FIG. 2 is a partially sectional detail side elevation view of said case, with the clamp in the angular position for freely opening the case;

FIG. 3 is a partially sectional detail side elevation view of the lock according to the invention, with the clamp in the angular position for closing the case;

FIG. 4 is a detail perspective view of the lock according to the invention;

FIG. 5 is another detail perspective view, taken from a different angle, of said lock;

FIG. 6 is an exploded detail perspective view of the lock;

FIG. 7 is another exploded detail perspective view, taken from a different angle, of said lock.

In the embodiment that follows, individual characteristics may actually be interchanged with other different characteristics that exist in other embodiments.

Moreover, it is noted that anything found to be already known during the patenting process is understood not to be claimed and to be the subject of a disclaimer.

### DESCRIPTION OF THE PREFERRED EMBODIMENTS

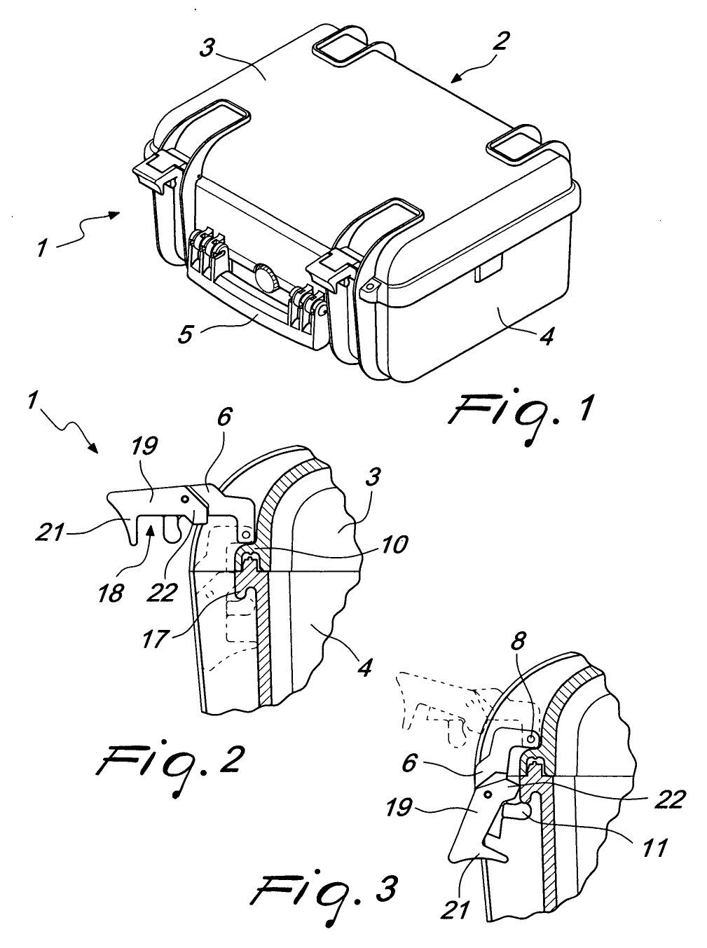

With reference to FIG. 1, the reference numeral 1 generally designates a lock, particularly for cases, trunks and the like according to the invention. In particular, in FIG. 1 two locks 1 according to the invention are fitted on a case, generally designated by the reference numeral 2, which is constituted by a first upper half-shell 3 and a second lower half-shell 4, which are mutually articulated at two or more hinges and are kept in contact with each other, in the closure configuration, by said locks; the case 2 is further provided at the front with a grip handle 5. It is specified here that the case can be of any type or size; likewise, locks according to the invention can be provided on a trunk or equally on other types of portable container.

The lock advantageously comprises, according to the invention, at least one clamp 6, which is pivoted, in an elongated articulation portion 7, to the first upper half-shell 3 at a first articulation axis 8 and forms an internal surface 9. The first articulation axis 8 is preferably located at the perimetric border 10 of the first half-shell 3, and sealing gaskets can be provided conveniently along the border 10; the clamp 6 conveniently has a substantially C-shaped transverse cross-section and forms a substantially folded end portion 11 provided with an expanded rim 12. The clamp 6 further forms two lateral curved portions 13 and 14 (FIGS. 6 and 7), at which the folded end portion 11 forms two respective lateral extensions 15 and 16. The clamp 6 can rotate, about the first articulation axis 8, from an angular position for closing the case 2, shown in FIG. 3, in which the folded end portion 11 is engaged below the edge 17 of the second half-shell 4, in order to keep it in hermetic contact with the perimetric border 10 of the first half-shell 3, to an angular position for freely opening the case 2 (FIG. 2), in which the folded end portion 11 is substantially disengaged from the edge 17, so as to allow to space the first half-shell 3 from the second half-shell 4. In particular, in the angular closure position of the clamp 6 the expanded rim 12 is engaged with a snap action below the edge 17 of the second half-shell 4.

According to the invention, the clamp 6 is provided advantageously with lever-type quick-release means that are actuated manually, are generally designated by the reference numeral 18, and are suitable to disengage easily and without effort the folded end portion 11 from the edge 17 of the second half-shell 4, so as to move the clamp 6 into the angular position for freely opening the case 2.

The lever-type quick-release means 18 conveniently comprise at least one lever 19, which is articulated to the clamp 6 at a second articulation axis 20, which is located at a substantially central portion and is preferably constituted by an optionally removable pivot (FIGS. 6 and 7). The lever 19 forms a first end 21 for manual actuation and a second end 22, said ends being mutually opposite; the lever 19 can rotate about the second articulation axis 20, by applying manually a modest opening torque to the first end 21, from an angular position for locking the case 2 (shown in broken lines in FIG. 2), in which the second end 22 is substantially retracted along the internal surface 9 of the clamp 6, to an angular position for releasing the clamp 6, in which the second end 22 protrudes substantially from the internal surface 9 of the clamp 6, so that it can apply a pressing action against the edge 17 and generate by reaction, on the clamp 6, a torque that is opposite to the torque applied manually, i.e., suitable to disengage the folded end portion 11 from the edge 17.

The lever 19 has a substantially C-shaped transverse cross-section. In particular, the first end 21 has a profile that is substantially concave in a lower region in order to facilitate the placement of the fingers in opening the lock. The second end 22 instead has a substantially wedge-shaped transverse cross-section and forms a flat surface 23 that is suitable to abut against the edge 17 with the lever 19 in the angular position for locking the case 2.

Conveniently, the lever 19 is affected in an upper region by a sort of rectangular recess 24, which forms two parallel arms 25 and 26, each of which is affected by respective holes 27 and 28 for inserting the pivot 20 for articulation to the clamp 6, each forming a respective second end 22 for pressing on the edge 17.

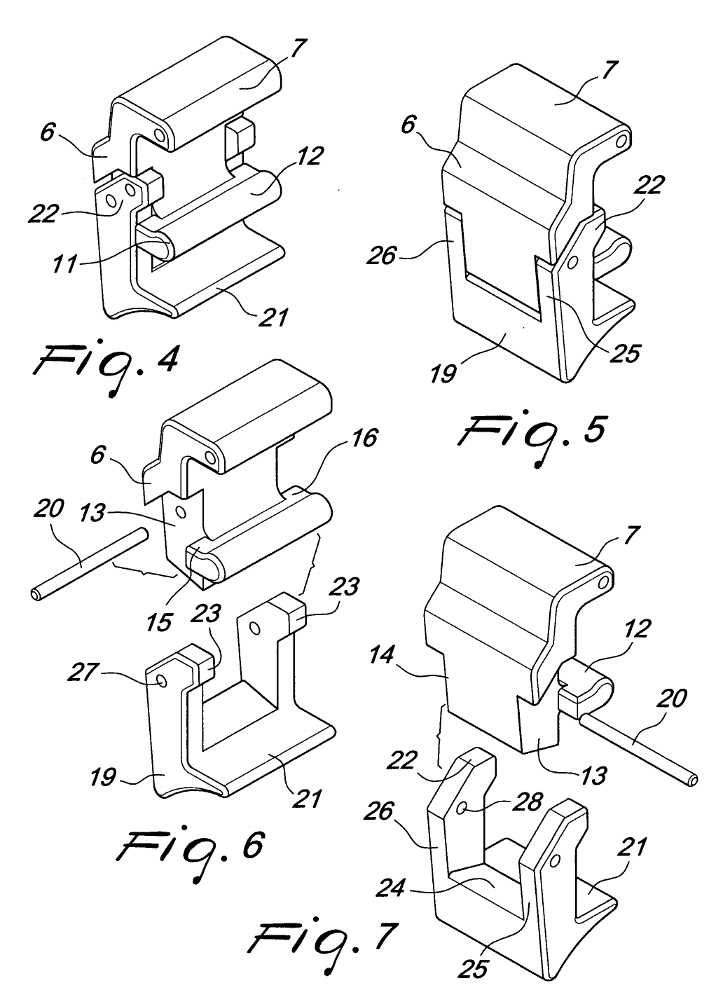

The parallel arms 25 and 26 are conveniently accommodated at the respective curved portions 13 and 14; the lateral extensions 15 and 16 of the folded end portion 11 conveniently constitute respective stops for the rotation of the two arms 25 and 26 in the angular position for locking the lever 19 (reference should be made in particular to FIGS. 4 and 5).

The operation of the lock according to the invention is intuitive. Assuming initially that the clamp 6 is in the angular position for closing the case 2 and the lever 19 is in the angular locking position (the situation shown in broken lines in FIG. 2), in order to open the lock the user has to apply a truly very small torque to the first end 21 of the lever 19, so as to turn it, about the second axis 20, from the angular locking position to the angular release position of the clamp 6 (the situation shown in solid lines in FIG. 3). As mentioned, this rotation causes the onset of a thrust by the second end 22 on the edge 17; by reaction, an opposite torque is generated accordingly on the clamp 6 about the first articulation axis 8, causing the disengagement of the folded end portion 11 (particularly of its enlarged rim 12) from the edge 17 (the situation shown in broken lines in FIG. 3), allowing to separate the first half-shell 3 from the second half-shell 4.

To close the lock again, it is instead necessary, starting from the situation shown in solid lines in FIG. 2 (i.e., with the clamp 6 in the angular position for freely opening the case 2), to rotate said clamp, by acting on the lever 19, until the folded end 11 engages with a snap action below the edge 17, applying a pressure that causes the edge 17 to adhere to the perimetric border 10 (also compressing the gaskets against each other, if present).

It has thus been shown that the invention achieves the intended aim and objects.

The hinge according to the invention certainly allows easier, faster and simpler opening of the case, while being constructively extremely simple and cheap.

The invention thus conceived is susceptible of numerous modifications and variations, all of which are within the scope of the appended claims.

All the details may further be replaced with other technically equivalent ones.

The embodiment of the present invention shall be carried out in the most scrupulous compliance with the statutory and regulatory provisions related to the products of the invention or correlated thereto and following any required authorization of the corresponding competent authorities, with particular reference to regulations related to safety, environmental pollution and health.

In practice, the materials used, as well as the shapes and the dimensions, may be any according to requirements without thereby abandoning the protective scope of the appended claims.

The disclosures in Italian Patent Application No. BO2004A000455 from which this application claims priority are incorporated herein by reference.

What is claimed is:

1. A lock for cases, having a first and a second half-shells and which is adapted to fasten hermetically against each other the first and the second half-shells, comprising: at least one clamp, which is articulated to said first half-shell and forms a substantially folded end portion, said clamp being rotatable from an angular position for closing the case, in which said folded end portion is engaged with a snap action under an edge of said second half-shell in order to keep the second half-shell in contact with said first half-shell, to an angular position for freely opening the case in which said folded end portion is disengaged from said edge, said clamp being provided with quick-release means of a lever type for rapid release thereof, said quick release means being manually actuatable and suitable to disengage said folded end portion from said edge so as to move said clamp into said angular position for freely opening the case.

2. The lock according to claim 1, wherein said lever-type quick-release means comprises at least one lever, which is articulated to said clamp at an axis of articulation located in a substantially central portion of the clamp, said lever having a first end and a second end, which are mutually opposite and being rotatable about the axis of articulation, by manual application of a limited opening torque to said first end, from an angular position for locking the case, in which said second end is substantially retracted along an internal surface of said clamp, to an angular position for releasing the clamp, in which said second end substantially protrudes from said internal surface so as to press against said edge and generate on said clamp, by reaction, a torque that is opposite to the torque applied to said lever and is suitable to disengage said folded end portion from said edge.

3. The lock of claim 2, wherein said clamp has a substantially C-shaped transverse cross-section and comprises a portion for articulation to said first half-shell, which is arranged opposite said folded end portion.

4. The lock of claim 3, wherein said lever has a substantially C-shaped transverse cross-section.

5. The lock of claim 2, wherein said second end of said lever has a substantially wedge-shaped transverse cross-section and forms a flat surface, which is suitable to abut along said edge with said lever in the angular position for locking the case.

6. The lock of claim 2, wherein said lever comprises in an upper region thereof a recess, and two parallel arms delimiting said recess, each of which is provided with respective holes for articulation to said clamp, said arms forming said second end suitable to apply pressure to said edge.

7. The lock of claim 6, wherein said clamp is provided with two lateral curved portions in which said arms of said lever engage.

8. The lock of claim 7, wherein said folded end portion of said clamp is provided with two lateral extensions, which are mutually opposite and are suitable to constitute respective stops for a rotation of said two arms in said angular position for locking said lever.
